(19) United States
(12) Patent Application Publication
(10) Pub. No.: US 2018/0306318 A1
(43) Pub. Date: Oct. 25, 2018

(54) Control Methods For A Ball-Type Continuously Variable Planetary

(71) Applicant: Dana Limited, Maumee, OH (US)

(72) Inventors: Jeffrey M. David, Cedar Park, TX (US); T. Neil McLemore, Georgetown, TX (US)

(21) Appl. No.: 15/939,526

(22) Filed: Mar. 29, 2018

Related U.S. Application Data
(60) Provisional application No. 62/478,787, filed on Mar. 30, 2017.

(51) Int. Cl. F16H 61/664; F16H 15/50

(52) U.S. Cl. CPC F16H 61/664; F16H 2059/704; F16H 15/503

(57) ABSTRACT

Provided herein is a computer-implemented system for a ball-planetary variator (CVP) having a plurality of tiltable balls supported in a carrier, the computer-implemented system including: a digital processing device including an operating system configured to perform executable instructions and a memory device; a computer program including instructions executable by the digital processing device and including a shift actuator controller configured to control a plurality of operating conditions of the CVP; and a plurality of sensors configured to monitor the operating conditions of the CVP including: a CVP speed ratio setpoint and an input torque to the CVP. The shift actuator controller includes an actuator force model configured to provide a shift force setpoint based on the CVP speed ratio set point and the input torque to the CVP and commands a change in a carrier position of the CVP based at least in part on the shift force setpoint.

### RELATED APPLICATION

This application claims priority to and the benefit from U.S. Provisional Patent Application Ser. No. 62/478,787 filed on Mar. 30, 2017 which is fully incorporated by reference herein.

### BACKGROUND

Automatic and manual transmissions are commonly used in the automotive market. Those transmissions have become more and more complicated since the engine speed has to be properly adjusted to improve fuel economy and minimize the emissions. This finer control of the engine speed in conventional transmissions can typically be done by adding extra gears but with increased overall complexity and cost. Thus, the number of gears for a usual manual transmission became six, seven or more for automatic transmissions.

In addition to these more conventional transmissions, Continuously Variable Transmissions (CVT) have been developed. CVTs are of many types including: belts with variable pulleys, toroidal, conical, etc. The main working principle of a CVT is that it enables the engine to run at its most efficient rotation speed by steplessly changing the transmission ratio as a function of the vehicle speed. However, there are still limitations regarding torque peaks and controllability of the speed ratio of the CVT in a number of different applications. Thus, there is a need for an improved method of control.

### SUMMARY

Provided herein is a computer-implemented system for a ball-planetary variator (CVP) having a plurality of tiltable balls supported in a carrier, the computer-implemented system including: a digital processing device including an operating system configured to perform executable instructions and a memory device; a computer program including instructions executable by the digital processing device, the computer program including a shift actuator controller configured to control a plurality of operating conditions of the CVP; a plurality of sensors configured to monitor the operating conditions of the CVP including: a CVP speed ratio setpoint and an input torque to the CVP; wherein the shift actuator controller includes a actuator force model configured to provide a shift force setpoint based on the CVP speed ratio set point and the input torque to the CVP, and wherein the shift actuator controller commands a change in a carrier position of the CVP based at least in part on the shift force setpoint.

Provided herein is a vehicle having a continuously variable planetary (CVP), wherein the CVP is a ball variator assembly having a first traction ring assembly and a second traction ring assembly in contact with a plurality of balls, wherein each ball of the plurality of balls has a tiltable axis of rotation supported by a first carrier member and a second carrier member, wherein a rotation of the first carrier member with respect to the second carrier member corresponds to a change in the tiltable axis of rotation; and a controller configured to control a CVP speed ratio using a shift actuator controller, wherein the shift actuator controller is configured to receive a CVP speed ratio setpoint and an input torque to the CVP and return an actuator pressure setpoint, and wherein the actuator pressure setpoint corresponds to a commanded position of the first carrier member with respect to the second carrier member.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

Novel features of the preferred embodiments are set forth with particularity in the appended claims. A better understanding of the features and advantages of the present embodiments will be obtained by reference to the following detailed description that sets forth illustrative embodiments, in which the principles of the preferred embodiments are utilized, and the accompanying drawings of which:

FIG. 1 is a side sectional view of a ball-type variator.

FIG. 2 is a plan view of a carrier member that can be used in the variator of FIG. 1.

FIG. 3 is an illustrative view of different tilt positions of the ball-type variator of FIG. 1.

FIG. 4 is a block diagram of a basic driveline configuration of a continuously variable transmission (CVT) used in a vehicle.

FIG. 5 is a schematic diagram depicting reaction forces on a ball used in the variator of FIG. 1.

FIG. 6 is a block diagram of a vehicle control system implementing the variator of FIG. 1.

FIG. 7 is a block diagram of a shift actuator controller implemented in the vehicle control system of FIG. 6.

FIG. 8 is a block diagram of another shift actuator controller implemented in the vehicle control system of FIG. 6.

### DETAILED DESCRIPTION OF THE PREFERRED EMBODIMENTS

The preferred embodiments relate to controlling the operating conditions of a Continuous Variable Transmission with an electronic control system configured to receive signals and execute commands based at least in part on a driver's torque or load request. The driver can give input to the vehicle in three ways: the brake pedal, the accelerator pedal, and other control button, switches, or knobs located within reach of the driver. The brake pedal and accelerator pedal input signals are mainly related to the requested total vehicle action. The controller described herein uses a plurality of measurements available which give information on this vehicle status. Some of the measurements or signals are engine speed, transmitted torque, transmission output speed, temperatures, gearbox settings, brake pedal position, accelerator pedal position (sometimes referred to as a gas pedal), engine throttle position, among others.

The preferred embodiments will now be described with reference to the accompanying figures, wherein like numerals refer to like elements throughout. The terminology used in the descriptions below is not to be interpreted in any limited or restrictive manner simply because it is used in conjunction with detailed descriptions of certain specific embodiments. Furthermore, embodiments can include several novel features, no single one of which is solely responsible for its desirable attributes or which is essential to practicing the preferred embodiments described.

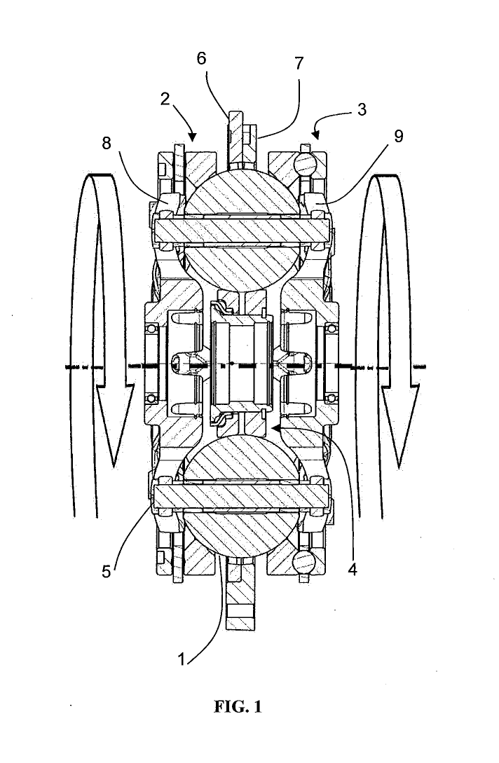

Provided herein are configurations of CVTs based on a ball-type variators, also known as CVP, for continuously variable planetary. Basic concepts of a ball-type Continuously Variable Transmissions are described in U.S. Pat. Nos. 8,469,856 and 8,870,711 incorporated herein by reference in their entirety. Such a CVT, adapted herein as described throughout this specification, includes a number of balls (planets, spheres) 1, depending on the application, two ring (disc) assemblies contact the balls, as input 2 and output 3, and an idler (sun) assembly 4 as shown on FIG. 1. The balls are mounted on tiltable axles 5, themselves held in a carrier (stator, cage) assembly having a first carrier member 6 operably coupled to a second carrier member 7. The first carrier member 6 can rotate with respect to the second carrier member 7, and vice versa. In some embodiments, the first carrier member 6 can be substantially fixed from rotation while the second carrier member 7 is configured to rotate with respect to the first carrier member, and vice versa. In some embodiments, the first carrier member 6 is provided with a number of radial guide slots 8. The second carrier member 7 is provided with a number of radially offset guide slots 9. The radial guide slots 8 and the radially offset guide slots 9 are adapted to guide the tiltable axles 5. The axles 5 are adjusted to achieve a desired ratio of input speed to output speed during operation of the CVT. In some embodiments, adjustment of the axles 5 involves control of the position of the first and second carrier members to impart a tilting of the axles 5 and thereby adjusts the speed ratio of the variator. Other types of ball CVTs also exist, like the one produced by Milner, but are slightly different.

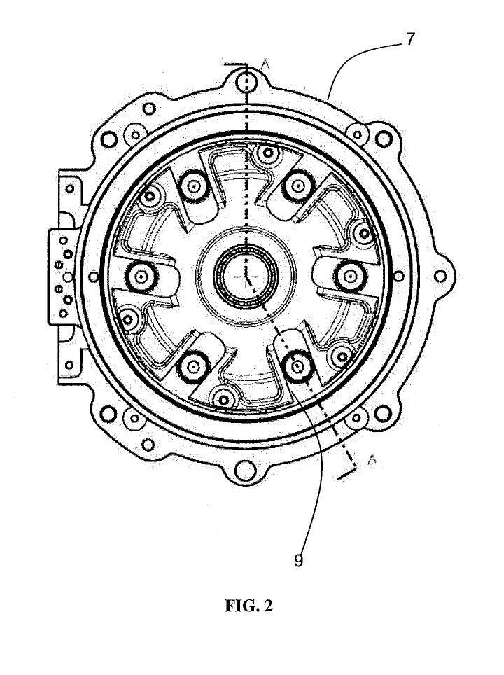

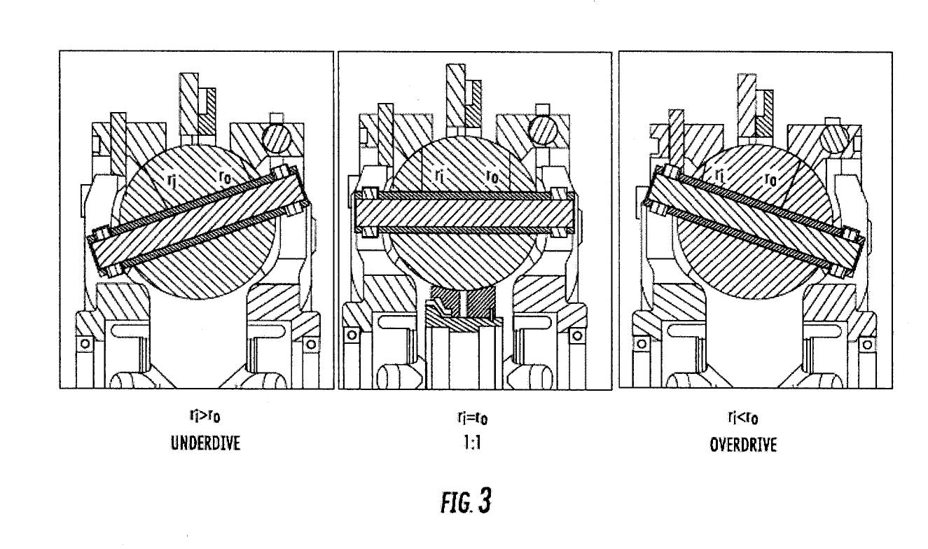

The working principle of such a CVP of FIG. 1 is shown on FIG. 2. The CVP itself works with a traction fluid. The lubricant between the ball and the rings acts as a solid at high pressure, transferring the power from the input ring, through the balls, to the output ring. By tilting the balls' axes, the ratio is changed between input and output. When the axis is horizontal the ratio is one, illustrated in FIG. 3, when the axis is tilted the distance between the axis and the contact point change, modifying the overall ratio. All the balls' axes are tilted at the same time with a mechanism included in the carrier and/or idler. Embodiments disclosed here are related to the control of a variator and/or a CVT using generally spherical planets each having a tiltable axis of rotation that is adjusted to achieve a desired ratio of input speed to output speed during operation. As used herein, the term “gamma” or “gamma angle” or “γ” refers to the tilt angle the ball axis makes with the longitudinal axis of the transmission. In some embodiments, adjustment of said axis of rotation involves angular misalignment of the planet axis in a first plane in order to achieve an angular adjustment of the planet axis in a second plane that is substantially perpendicular to the first plane, thereby adjusting the speed ratio of the variator. The angular misalignment in the first plane is referred to here as “skew”, “skew angle”, and/or “skew condition”. In some embodiments, a control system coordinates the use of a skew angle to generate forces between certain contacting components in the variator that will tilt the planet axis of rotation. The tilting of the planet axis of rotation adjusts the speed ratio of the variator.

As used here, the terms “operationally connected,” “operationally coupled”, “operationally linked”, “operably connected”, “operably coupled”, “operably linked,” and like terms, refer to a relationship (mechanical, linkage, coupling, etc.) between elements whereby operation of one element results in a corresponding, following, or simultaneous operation or actuation of a second element. It is noted that in using said terms to describe the embodiments, specific structures or mechanisms that link or couple the elements are typically described. However, unless otherwise specifically stated, when one of said terms is used, the term indicates that the actual linkage or coupling may take a variety of forms, which in certain instances will be readily apparent to a person of ordinary skill in the relevant technology.

For description purposes, the term “radial” is used here to indicate a direction or position that is perpendicular relative to a longitudinal axis of a transmission or variator. The term “axial” as used here refers to a direction or position along an axis that is parallel to a main or longitudinal axis of a transmission or variator. For clarity and conciseness, at times similar components labeled similarly (for example, a control piston 123A and a control piston 123B) will be referred to collectively by a single label (for example, control pistons 123).

It should be noted that reference herein to “traction” does not exclude applications where the dominant or exclusive mode of power transfer is through “friction.” Without attempting to establish a categorical difference between traction and friction drives here, generally these may be understood as different regimes of power transfer. Traction drives usually involve the transfer of power between two elements by shear forces in a thin fluid layer trapped between the elements. The fluids used in these applications usually exhibit traction coefficients greater than conventional mineral oils. The traction coefficient GO represents the maximum available traction force which would be available at the interfaces of the contacting components and is the ratio of the maximum available drive torque per contact force. Typically, friction drives generally relate to transferring power between two elements by frictional forces between the elements. For the purposes of this disclosure, it should be understood that the CVTs described here may operate in both tractive and frictional applications. For example, in the embodiment where a CVT is used for a bicycle application, the CVT can operate at times as a friction drive and at other times as a traction drive, depending on the torque and speed conditions present during operation.

As used herein, “creep”, “ratio droop”, or “slip” is the discrete local motion of a body relative to another and is exemplified by the relative velocities of rolling contact components such as the mechanism described herein. In traction drives, the transfer of power from a driving element to a driven element via a traction interface requires creep. Usually, creep in the direction of power transfer is referred to as “creep in the rolling direction.” Sometimes the driving and driven elements experience creep in a direction orthogonal to the power transfer direction, in such a case this component of creep is referred to as “transverse creep.” It should be understood, that speed ratio droops with increasing torque due to the local shearing of the traction fluid at the contacting components. As speed ratio droops the torque ratio rises, and thus the CVP naturally exhibits some degree of response to changing torque demands. Control methods described herein are optionally configured to account for the speed ratio droop through appropriate feedback and mapping of the transmission hardware.

For description purposes, the terms “electronic control unit”, “ECU”, “Driving Control Manager System” or “DCMS” are used interchangeably herein to indicate a vehicle's electronic system that controls subsystems monitoring or commanding a series of actuators on an internal combustion engine to ensure optimal engine performance. It does this by reading values from a multitude of sensors within the engine bay, interpreting the data using multidimensional performance maps (called lookup tables), and adjusting the engine actuators accordingly. Before ECUs, air-fuel mixture, ignition timing, and idle speed were mechanically set and dynamically controlled by mechanical and pneumatic means. As used herein, a sensor is optionally configured to be a physical device, a virtual device, or any combination of the two. For example, a physical device is optionally configured to provide information to form a parameter for use in an electronic module. In some embodiments, as used herein, a speed sensor is either a physical device or a virtual device implemented in software to sense a speed of a rotating component.

Those of skill will recognize that brake position and throttle position sensors are electronic, and in some cases, well-known potentiometer type sensors. These sensors provide a voltage or current signal that is indicative of a relative rotation and/or compression/depression of driver control pedals, for example, brake pedal and/or throttle pedal. Often, the voltage signals transmitted from the sensors are scaled. A convenient scale used in the present application as an illustrative example of one implementation of the control system uses a percentage scale 0%-100%, where 0% is indicative of the lowest signal value, for example a pedal that is not compressed, and 100% is indicative of the highest signal value, for example a pedal that is fully compressed. In some embodiments, there may be implementations of the control system where the brake pedal is effectively fully engaged with a sensor reading of 20%-100%. Likewise, in some embodiments, a fully engaged throttle pedal corresponds to a throttle position sensor reading of 20%-100%. The sensors, and associated hardware for transmitting and calibrating the signals, are optionally selected in such a way as to provide a relationship between the pedal position and signal to suit a variety of implementations. Numerical values given herein are included as examples of one implementation and not intended to imply limitation to only those values. For example, in some embodiments, a minimum detectable threshold for a brake pedal position is 6% for a particular pedal hardware, sensor hardware, and electronic processor. Whereas an effective brake pedal engagement threshold is 14%, and a maximum brake pedal engagement threshold begins at or about 20% compression. As a further example, in some embodiments, a minimum detectable threshold for an accelerator pedal position is 5% for a particular pedal hardware, sensor hardware, and electronic processor. In some embodiments, similar or completely different pedal compression threshold values for effective pedal engagement and maximum pedal engagement are also applied for the accelerator pedal.

As used herein, and unless otherwise specified, the term “about” or “approximately” means an acceptable error for a particular value as determined by one of ordinary skill in the art, which depends in part on how the value is measured or determined.

Those of skill will recognize that in some embodiments, the various illustrative logical blocks, modules, circuits, and algorithm steps described in connection with the embodiments disclosed herein, including with reference to the transmission control system described herein, for example, are implemented as electronic hardware, software stored on a computer readable medium and executable by a processor, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention. For example, various illustrative logical blocks, modules, and circuits described in connection with the embodiments disclosed herein are implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. In some embodiments, a processor will be implemented as a combination of computing devices, e.g., a combination of a DSP and a microprocessor, a plurality of microprocessors, one or more microprocessors in conjunction with a DSP core, or any other such configuration. In some embodiments, software associated with such modules resides in RAM memory, flash memory, ROM memory, EPROM memory, EEPROM memory, registers, a hard disk, a removable disk, a CD-ROM, or any other suitable form of storage medium known in the art. In some embodiments, an exemplary storage medium is coupled to the processor such that the processor reads information from, and writes information to, the storage medium. In alternative embodiments, the storage medium is integral to the processor. In some embodiments, the processor and the storage medium reside in an ASIC. For example, in some embodiments, a controller for use of control of the IVT includes a processor (not shown).

### Certain Definitions

Unless otherwise defined, all technical terms used herein have the same meaning as commonly understood by one of ordinary skill in the art to which this invention belongs. As used in this specification and the appended claims, the singular forms “a,” “an,” and “the” include plural references unless the context clearly dictates otherwise. Any reference to “or” herein is intended to encompass “and/or” unless otherwise stated.

### Digital Processing Device

In some embodiments, the Control System for a Vehicle equipped with an infinitely variable transmission described herein includes a digital processing device, or use of the same. In further embodiments, the digital processing device includes one or more hardware central processing units (CPU) that carry out the device's functions. In still further embodiments, the digital processing device further includes an operating system configured to perform executable instructions. In some embodiments, the digital processing device is optionally connected a computer network. In further embodiments, the digital processing device is optionally connected to the Internet such that it accesses the World Wide Web. In still further embodiments, the digital processing device is optionally connected to a cloud computing infrastructure. In other embodiments, the digital processing device is optionally connected to an intranet. In other embodiments, the digital processing device is optionally connected to a data storage device.

In accordance with the description herein, suitable digital processing devices include, by way of non-limiting examples, server computers, desktop computers, laptop computers, notebook computers, sub-notebook computers, netbook computers, netpad computers, set-top computers, media streaming devices, handheld computers, Internet appliances, mobile smartphones, tablet computers, personal digital assistants, and vehicles. Those of skill in the art will recognize that many smartphones are suitable for use in the system described herein.

In some embodiments, the digital processing device includes an operating system configured to perform executable instructions. The operating system is, for example, software, including programs and data, which manages the device's hardware and provides services for execution of applications. Those of skill in the art will recognize that suitable server operating systems include, by way of non-limiting examples, FreeBSD, OpenBSD, NetBSD®, Linux, Apple® Mac OS X Server®, Oracle® Solaris®, Windows Server®, and Novell® NetWare®. Those of skill in the art will recognize that suitable personal computer operating systems include, by way of non-limiting examples, Microsoft® Windows®, Apple® Mac OS X®, UNIX®, and UNIX-like operating systems such as GNU/Linux®. In some embodiments, the operating system is provided by cloud computing. Those of skill in the art will also recognize that suitable mobile smart phone operating systems include, by way of non-limiting examples, Nokia® Symbian® OS, Apple® iOS®, Research In Motion® BlackBerry OS®, Google® Android®, Microsoft® Windows Phone® OS, Microsoft® Windows Mobile® OS, Linux®, and Palm® WebOS®.

In some embodiments, the device includes a storage and/or memory device. The storage and/or memory device is one or more physical apparatuses used to store data or programs on a temporary or permanent basis. In some embodiments, the device is volatile memory and requires power to maintain stored information. In some embodiments, the device is non-volatile memory and retains stored information when the digital processing device is not powered. In further embodiments, the non-volatile memory includes flash memory. In some embodiments, the non-volatile memory includes dynamic random-access memory (DRAM). In some embodiments, the non-volatile memory includes ferroelectric random access memory (FRAM). In some embodiments, the non-volatile memory includes phase-change random access memory (PRAM). In other embodiments, the device is a storage device including, by way of non-limiting examples, CD-ROMs, DVDs, flash memory devices, magnetic disk drives, magnetic tapes drives, optical disk drives, and cloud computing based storage. In further embodiments, the storage and/or memory device is a combination of devices such as those disclosed herein.

In some embodiments, the digital processing device includes a display to send visual information to a user. In some embodiments, the display is a cathode ray tube, (CRT). In some embodiments, the display is a liquid crystal display (LCD). In further embodiments, the display is a thin film transistor liquid crystal display (TFT-LCD). In some embodiments, the display is an organic light emitting diode (OLED) display. In various further embodiments, on OLED display is a passive-matrix OLED (PMOLED) or active-matrix OLED (AMOLED) display. In some embodiments, the display is a plasma display. In other embodiments, the display is a video projector. In still further embodiments, the display is a combination of devices such as those disclosed herein.

In some embodiments, the digital processing device includes an input device to receive information from a user. In some embodiments, the input device includes, by way of non-limiting examples, a keyboard, a mouse, trackball, track pad, joystick, stylus, a touch screen, a multi-touch screen, a microphone to capture voice or other sound input, a video camera or other sensor to capture motion or visual input. In still further embodiments, the input device is a combination of devices such as those disclosed herein.

### Non-Transitory Computer Readable Storage Medium

In some embodiments the Control System for a Vehicle equipped with an infinitely variable transmission disclosed herein includes one or more non-transitory computer readable storage media encoded with a program including instructions executable by the operating system of an optionally networked digital processing device. In further embodiments, a computer readable storage medium is a tangible component of a digital processing device. In still further embodiments, a computer readable storage medium is optionally removable from a digital processing device. In some embodiments, a computer readable storage medium includes, by way of non-limiting examples, CD-ROMs, DVDs, flash memory devices, solid state memory, magnetic disk drives, magnetic tape drives, optical disk drives, cloud computing systems and services, and the like. In some cases, the program and instructions are permanently, substantially permanently, semi-permanently, or non-transitorily encoded on the media.

### Computer Program

In some embodiments, the Control System for a Vehicle equipped with an infinitely variable transmission disclosed herein includes at least one computer program, or use of the same. A computer program includes a sequence of instructions, executable in the digital processing device's CPU, written to perform a specified task. Computer readable instructions may be implemented as program modules, such as functions, objects, Application Programming Interfaces (APIs), data structures, and the like, that perform particular tasks or implement particular abstract data types. In light of the disclosure provided herein, those of skill in the art will recognize that a computer program may be written in various versions of various languages.

The functionality of the computer readable instructions may be combined or distributed as desired in various environments. In some embodiments, a computer program includes one sequence of instructions. In some embodiments, a computer program includes a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

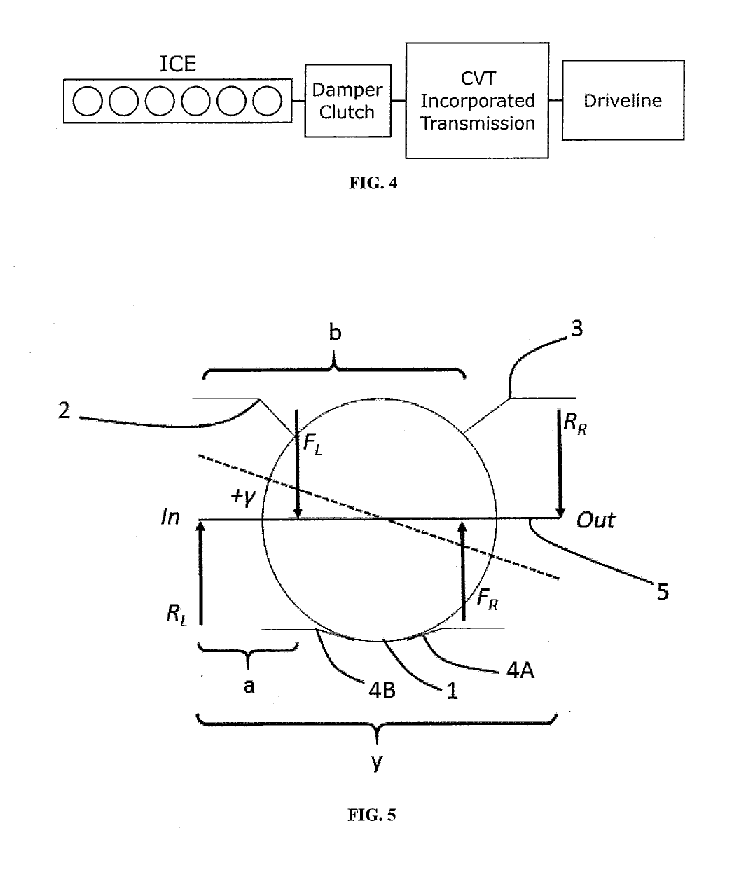

Referring now to FIG. 4, in some embodiments, a vehicle can be equipped with a driveline having a torsional damper between an engine and an infinitely or continuously variable transmission (CVT) to avoid transferring torque peaks and vibrations that could damage the CVT (called variator in this context as well). In some configurations, the damper is optionally coupled with a clutch for the starting function or to allow the engine to be decoupled from the transmission. In yet other embodiments, a torque converter may be used in place of the torsional damper. Other types of CVT's (apart from ball-type traction drives) are optionally used as the variator in this layout. In addition to the configurations above where the variator is used directly as the primary transmission, other architectures are possible.

Various powerpath layouts are optionally introduced by adding a number of gears, clutches and simple or compound planetaries. In such configurations, the overall transmission provides several operating modes; a CVT, an IVT, a combined mode and so on. Basic concepts of torque control methods and systems for a CVP are described in pending PCT application No. PCT/US16/054095 incorporated herein by reference in their entirety. A control system for use in an infinitely or continuously variable transmission will now be described.

Moving now to FIG. 5, during operation of the CVP, the first carrier member 6 is adapted to rotate relative to the second carrier member 7. The first carrier member 6 and the second carrier member 7 impart forces on the axles of the ball. The reaction forces in the x-y plane are as follows:
The left end of the ball axle (when viewed with respect to FIG. 5) puts a force R_{L} on carrier 1.
The right end ball axle puts a force R_{R} on carrier 2.
The ball surface puts a traction force F_{L} on the input ring.
The ball surface puts a traction force F_{R} on the output ring.

In some embodiments, a shift actuator (not shown) is optionally implemented to control the position of the first carrier member 6 with respect to the second carrier member 7. Control of the actuator is optionally configured to be a cascade of a position controller, speed controller and a current controller or a combination of these loops in both feedback and feedforward variants. The driver circuit of an electric actuator receives a control command which relates to a certain setpoint for a carrier position (sometimes referred to as “P” representing the angular rotation of the first carrier member with respect to the second carrier member when viewed in the plane of the page of FIG. 2), to be able to set the speed ratio. The shift actuator is optionally an electromotor or a solenoid, for example. In other embodiments, a hydraulic actuator may be implemented and the operating pressure of the hydraulic actuator may be used to position the carrier member.

The amount of force or torque the shift actuator instantaneously requires is related to the torque exerted on the carriers by the balls and the acceleration of the actuator and carrier. In steady state operation the acceleration is zero. A higher torque required for the shift actuator to reach a commanded set point indicates a higher torque on the carrier. Thus, the torque applied by the shift actuator is a measure of the torque on the first carrier member 6, for example. For electric shift actuators, the torque output of the shift actuator is in relation to its electrical current consumption. The electrical current draw is optionally used to measure the torque. For hydraulic shift actuators, the torque output of the shift actuator is in relation to its hydraulic pressure. The hydraulic pressure is optionally used to measure the force on the shift actuator and thereby determine the torque on the carrier. A control algorithm that uses the shift actuator force to measure carrier torque includes a method to compensate for dynamic effects during actuation, for example, inertial effects, transients due to actuation mechanism, dead time, among others, and hysteresis effects.

Still referring to FIG. 5, traction forces (F_{L} and F_{R}) are considered tangential and are a result of applied ring torques (Tᵢₙ and Tₒᵤₜ). Carrier forces (F_{carrier}_{_}ᵢₙ and F_{carrier}_{_}ₒᵤₜ) are calculated from the force balance on the planet axle. Input carrier force (F_{carrier}_{_}ᵢₙ) is a force due to fixed input. The rotatable output carrier force (F_{carrier}_{_}ₒᵤₜ) is calculated from the summation of moments about the fixed input carrier and is considered the minimum required shift force.

$${F}_{L} = \frac{{T}_{i n}}{{r}_{traction}}$$

$${F}_{R} = \frac{- {T}_{out}}{{r}_{traction}}$$

$${r}_{traction} = traction radius = {r}_{s} + {r}_{p} + {r}_{p} * cos ( {α}_{1} )$$

### Summation of Moments

$$\sum {M}_{I} = 0$$

$${F}_{carrier \_ i n} * 0 + {F}_{L} * a + {F}_{R} * b + {F}_{carrier \_ out} * y = 0$$

$${F}_{carrier \_ out} = \frac{- ( {F}_{R} * a + {F}_{L} * b )}{y}$$

The equations below translate carrier force (F_{carrier}_{_}ₒᵤₜ) on the planet axle into a carrier torque (T_{shift}_{_}_{carrier}) based an effective carrier radius (r_{eff}) that changes with the tilting of the ball axis, for example a changing gamma angle (γ), and then translates back into an actuator shift force at the actuator drive gear based on a static carrier radius (r_{carrier}) from CVP centerline to the actuator drive gear. In some embodiments, the actuator drive gear is a member configured to drivingly couple the actuator to the rotatable carrier member of the variator.

$$carrier effective radius = {r}_{eff} = {r}_{s} + {r}_{p} - \frac{{L}_{pa} * sin ( γ )}{2}$$

$$carrier shift torque = {T}_{shift \_ carrier} = {F}_{carrier \_ out} * {r}_{eff}$$

$$actuator shift force = \frac{{T}_{shift \_ carrier}}{{r}_{carrier}}$$

### Variator Geometry Parameters

$$a = \frac{{L}_{pa} * cos ( γ )}{2} - \frac{{L}_{pcs}}{2}$$

$$b = \frac{{L}_{pa} * cos ( γ )}{2} + \frac{{L}_{pcs}}{2}$$

$$y = {L}_{pa} * cos ( γ )$$

L_{pcs} ball contact separation=Dₚ*sin(α)
Dₚ=ball diameter
rₚ=ball radius
α=traction contact angle
r_{carrier}=static carrier radius
rₛ=sun radius
Lₚₐ=ball axle length

Equations above are implementable in a spreadsheet and Simulink subsystem form. Physical validation of the model is done with a strain gauge applied to the carrier, for example. As will be discussed below, the relationships defined by the equations above form a computer implementable model used for control of the variator.

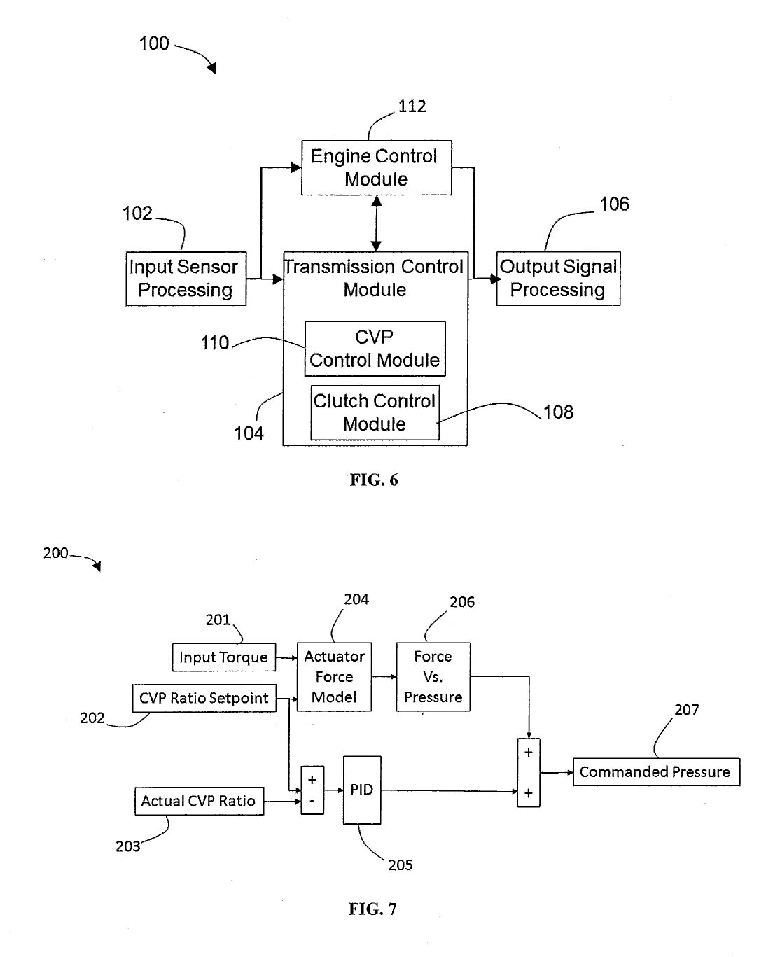

Referring now to FIG. 6, in some embodiments, a vehicle control system 100 includes an input signal processing module 102, a transmission control module 104 and an output signal processing module 106. The input signal processing module 102 is configured to receive a number of electronic signals from sensors provided on the vehicle and/or transmission. The sensors optionally include temperature sensors, speed sensors, position sensors, among others. In some embodiments, the signal processing module 102 optionally includes various sub-modules to perform routines such as signal acquisition, signal arbitration, or other known methods for signal processing. The output signal processing module 106 is optionally configured to electronically communicate to a variety of actuators and sensors. In some embodiments, the output signal processing module 106 is configured to transmit commanded signals to actuators based on target values determined in the transmission control module 104. The transmission control module 104 optionally includes a variety of sub-modules or sub-routines for controlling continuously variable transmissions of the type discussed here. For example, the transmission control module 104 optionally includes a clutch control sub-module 108 that is programmed to execute control over clutches or similar devices within the transmission. In some embodiments, the clutch control sub-module implements state machine control for the coordination of engagement of clutches or similar devices. The transmission control module 104 optionally includes a CVP control sub-module 110 programmed to execute a variety of measurements and determine target operating conditions of the CVP, for example, of the ball-type continuously variable transmissions discussed here.

It should be noted that the CVP control sub-module 110 optionally incorporates a number of sub-modules for performing measurements and control of the CVP. In some embodiments, the vehicle control system 100 includes an engine control module 112 configured to receive signals from the input signal processing module 102 and in communication with the output signal processing module 106. The engine control module 112 is configured to communicate with the transmission control module 104.

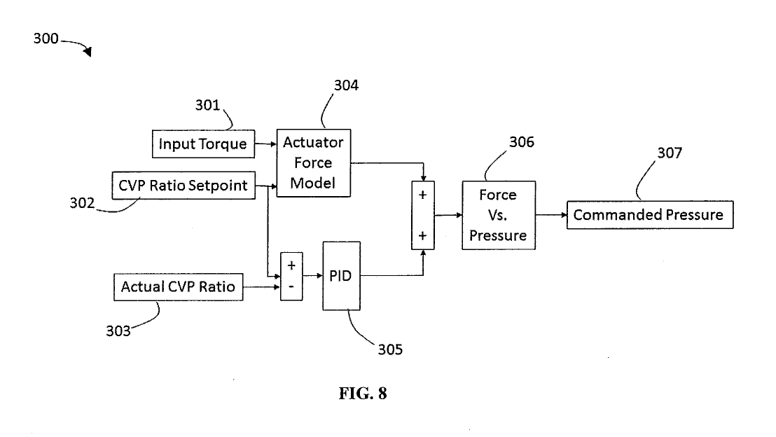

Referring now to FIG. 7, in some embodiments, the CVP control module 110 is configured to include a shift actuator controller 200. The shift actuator controller 200 receives an input torque 201, a CVP ratio setpoint 202, and an actual CVP ratio 203 from other sub-modules of the vehicle control system 100 such as the transmission control module 104 and the engine control module 112. The input torque 201 and the CVP ratio setpoint 202 are passed to an actuator force model 204. As described previously, the actuator force model 204 is a computer-implemented model of the physical relationships described in reference to FIG. 5. The actuator force model 204 returns a shift force setpoint that is passed to a force-to-pressure converter 206. The force-to-pressure converter 206 returns an actuator pressure setpoint. A difference between the CVP ratio setpoint 202 and the actual CVP ratio 203 forms an error that is passed to a PID module 205. Typically, a PID controller, otherwise known as a proportional-integral-derivative controller, is configured for receiving a difference between a set point and a controlled variable of a process to be controlled and delivering a manipulated variable to the process, the process being operated by the manipulated variable to produce the controlled variable. The PID module 205 returns an actuator pressure adjustment that is summed with the actuator pressure setpoint determined by the force-to-pressure converter 206 to form a commanded pressure 207. The commanded pressure 207 is provided to other modules of the transmission controller 104 to control the shift actuator coupled to the carrier of the variator.

Turning now to FIG. 8, in some embodiments, the CVP control module 110 is configured to include a shift actuator controller 300. The shift actuator controller 300 receives an input torque 301, a CVP ratio setpoint 302, and an actual CVP ratio 303 from other sub-modules of the vehicle control system 100 such as the transmission control module 104 and the engine control module 112. The input torque 301 and the CVP ratio setpoint 302 are passed to an actuator force model 304. As described previously, the actuator force model 304 is a computer-implemented model of the physical relationships described in reference to FIG. 5. The actuator force model 304 returns an actuator force setpoint. A difference between the CVP ratio setpoint 302 and the actual CVP ratio 303 forms an error that is passed to a PID module 305. Typically, a PID controller, otherwise known as a proportional-integral-derivative controller, is configured for receiving a difference between a set point and a controlled variable of a process to be controlled and delivering a manipulated variable to the process, the process being operated by the manipulated variable to produce the controlled variable. The PID module 305 returns an actuator force adjustment that is summed with the actuator force setpoint determined by the actuator force model 304. The summation is passed to a force-to-pressure converter 306 to determine a commanded pressure 307. The commanded pressure 307 is provided to other modules of the transmission controller 104 to control the shift actuator coupled to the carrier of the variator.

It should be noted that the description above has provided dimensions for certain components or subassemblies. The mentioned dimensions, or ranges of dimensions, are provided in order to comply as best as possible with certain legal requirements, such as best mode. However, the scope of the preferred embodiments described herein are to be determined solely by the language of the claims, and consequently, none of the mentioned dimensions is to be considered limiting on the inventive embodiments, except in so far as any one claim makes a specified dimension, or range of thereof, a feature of the claim.

While preferred embodiments have been shown and described herein, it will be obvious to those skilled in the art that such embodiments are provided by way of example only. Numerous variations, changes, and substitutions will now occur to those skilled in the art without departing from the preferred embodiments. It should be understood that various alternatives to the embodiments described herein may be employed in practicing the invention. It is intended that the following claims define the scope of the preferred embodiments and that methods and structures within the scope of these claims and their equivalents be covered thereby.

What is claimed is:

1. A computer-implemented system for a ball-planetary variator (CVP) having a plurality of tiltable balls supported in a carrier, the computer-implemented system comprising:
a digital processing device comprising an operating system configured to perform executable instructions and a memory device;
a computer program including instructions executable by the digital processing device, the computer program comprising a shift actuator controller configured to control a plurality of operating conditions of the CVP;
a plurality of sensors configured to monitor the operating conditions of the CVP comprising:
a CVP speed ratio setpoint and
an input torque to the CVP,
wherein the shift actuator controller comprises an actuator force model configured to provide a shift force setpoint based on the CVP speed ratio setpoint and the input torque to the CVP, and
wherein the shift actuator controller commands a change in a carrier position of the CVP based at least in part on the shift force setpoint.

2. The computer-implemented system of claim 1, wherein the shift actuator controller further comprises a PID module configured to receive the CVP speed ratio setpoint and an actual CVP speed ratio.

3. The computer-implemented system of claim 2, wherein the PID module returns an actuator pressure adjustment based on the difference between the CVP speed ratio setpoint and the actual CVP speed ratio.

4. The computer-implemented system of claim 2, wherein the PID module returns an actuator force adjustment based on the difference between the CVP speed ratio setpoint and the actual CVP speed ratio.

5. The computer-implemented system of claim 1, wherein the actuator force model is programmed to determine the shift force setpoint by calculating a torque on the carrier of the CVP based on the input torque to the CVP and a tilt angle of the ball axis.

6. The computer-implemented system of claim 5, wherein the shift actuator controller further comprises a force-to-pressure converter configured to convert the shift force setpoint to an actuator pressure setpoint.

7. A vehicle comprising:
a continuously variable planetary (CVP), wherein the CVP is a ball variator assembly having a first traction ring assembly and a second traction ring assembly in contact with a plurality of balls, wherein each ball of the plurality of balls has a tiltable axis of rotation supported by a first carrier member and a second carrier member, wherein a rotation of the first carrier member with respect to the second carrier member corresponds to a change in the tiltable axis of rotation; and
a controller configured to control a CVP speed ratio using a shift actuator controller,
wherein the shift actuator controller is configured to receive a CVP speed ratio setpoint and an input torque to the CVP and return an actuator pressure setpoint, and
wherein the actuator pressure setpoint corresponds to a commanded position of the first carrier member with respect to the second carrier member.

8. The vehicle of claim 7, wherein the shift actuator controller further comprises an actuator force model configured to relate the input torque to the CVP and the CVP speed ratio setpoint to a shift force setpoint based on a plurality of dimensions of the CVP, wherein the plurality of dimensions of the CVP includes a ball diameter, a ball axle length, and an effective radius of the first carrier member.

9. The vehicle of claim 7, wherein the shift actuator controller further comprises a PID module configured to provide an actuator pressure setpoint based on the difference between the CVP speed ratio setpoint and an actual CVP speed ratio.

10. The vehicle of claim 7, wherein the shift actuator controller further comprises a PID module configured to provide a shift force setpoint based on the difference between the CVP speed ratio setpoint and an actual CVP speed ratio.
